(19) United States
(12) Patent Application Publication
(10) Pub. No.: US 2025/0385713 A1
(43) Pub. Date: Dec. 18, 2025

(54) TRANSMISSION METHOD AND OMAMRC SYSTEM WITH A SELECTION STRATEGY DURING RETRANSMISSIONS TAKING INTO ACCOUNT THE THROUGHPUT OF THE SOURCES AND OF ONE OR MORE CONTROL EXCHANGES

(71) Applicant: Orange, Issy-les-Moulineaux (FR)

(72) Inventors: Ali Al Khansa, Châtillon (FR); Raphael Visoz, Châtillon (FR)

(21) Appl. No.: 18/877,169

(22) PCT Filed: Jun. 23, 2023
(86) PCT No.: PCT/EP2023/067084

§ 371 Date: Dec. 19, 2024

(30) Foreign Application Priority Data
Jun. 28, 2022 (FR) 2206446

(51) Int. Cl. H04B 7/024; H04L 1/1812; H04L 5/16

(52) U.S. Cl. CPC H04B 7/024; H04L 1/1812; H04L 5/16

(57) ABSTRACT

A method is described for transmitting a frame carrying messages for an OMAMRC telecommunication system having N nodes, including M sources sᵢi∈{1, . . . , M} and a destination, where N≥M≥2. The method involves estimating a number of retransmission intervals sufficient for the destination to decode a source not yet correctly decoded and correctly decoded by at least one node on the basis of the quality of an equivalent channel for said source between said at least one node and the destination and of a throughput assigned to said source. The method also involves having the destination select the sources to be assisted taking into account the estimated numbers of retransmission intervals sufficient for the destination to decode the sources not yet correctly decoded and of a sum of throughputs assigned to the sources, and a number of retransmission intervals per source defining an allowed duration for assisting a source during said allowed duration limited by a time remaining until a maximum time even if the estimated number of retransmission intervals sufficient for this source is greater than the remaining time.

### FIELD OF THE INVENTION

The present invention relates to the field of digital communications. Within this field, the invention relates more particularly to the transmission of coded data between at least two sources and a destination with relaying by at least one node that may be a relay or a source.

It is understood that a relay does not have a message to transmit. A relay is a node dedicated to relaying the messages from the sources, whereas a source has its own message to transmit and may also, in some cases, relay the messages from the other sources, i.e. the source is known as cooperative in this case.

Numerous relaying techniques are known: “amplify and forward”, “decode and forward”, “compress-and-forward”, “non-orthogonal amplify and forward”, “dynamic decode and forward”, etc.

The invention applies in particular, but not exclusively, to the transmission of data via mobile networks, for example for real-time applications, or via for example sensor networks.

Such a sensor network is a multi-user network, consisting of multiple sources, multiple relays and a recipient using an orthogonal time-division multiple access scheme of the transmission channel between the relays and the sources, referred to as OMAMRC (“Orthogonal Multiple-Access Multiple-Relay Channel”).

### PRIOR ART

The OMAMRC telecommunication system under consideration illustrated in FIG. 1 has N nodes and a destination with an implementation of an orthogonal time-division multiple access scheme of the transmission channel that applies between the N nodes. The N nodes include M sources and L relays. The maximum number of time slots per transmitted frame is M+Tₘₐₓ with M slots allocated during a first phase to the successive transmission of the M sources and T_{used}≤Tₘₐₓ slots for one or more cooperative transmissions allocated during a second phase to one or more nodes selected by the destination according to a selection strategy.

Such an OMAMRC transmission system implementing a selection strategy during the second phase is known from the article by S. Cerović, R. Visoz, and L. Madier entitled “Efficient Cooperative HARQ for Multi-Source Multi-Relay Wireless Networks.”, 14th International Conference on Wireless and Mobile Computing, Networking and Communications (WiMob). IEEE, 2018. The OMAMRC transmission system described is such that each of the sources is able to operate at different times either exclusively as a source or as a relay node. The term node covers both a relay and a source acting as a relay node or as a source. A relay differs from a source since it has no message to transmit that is specific thereto, i.e. it retransmits only messages coming from other nodes.

The links between the various nodes of the system are subject to slow fading and to white Gaussian noise. Knowledge of all of the links in the system (CSI: Channel State Information) by the destination is not available. In point of fact, the links between the sources, between the relays, between the relays and the sources are not able to be observed directly by the destination, and knowledge of said links by the destination would require an excessive exchange of information between the sources, the relays and the destination. In order to limit the cost of the feedback overhead, represented by dotted lines in FIG. 1, only information about the distribution/statistics of the channels (CDI: Channel Distribution Information) of all of the links, e.g. average quality (for example average SNR, average SINR) of all of the links, is assumed to be known by the destination for the purpose of determining the throughputs allocated to the sources.

Link adaptation is known as slow link adaptation, i.e. before any transmission, the destination allocates initial throughputs to the sources in light of the distribution of all channels (CDI: Channel Distribution Information). In general, it is possible to return to the CDI distribution on the basis of knowledge of the average SNR or SINR of each link in the system.

Source message transmissions are formatted into frames during which the CSIs of the links are assumed to be constant (slow fading scenario). The throughput allocation is assumed not to change for several hundred frames, and it changes only with changes in CDI.

The method distinguishes between three phases: an initial phase and, for each frame to be transmitted, a 1st phase and a 2nd phase. The transmission of a frame takes place in two phases that are possibly preceded by an additional phase known as the initial phase.

In the initialization phase, the destination determines an initial throughput Rᵢ for each source sᵢ, taking into account the average quality (for example SNR) of each of the links in the system.

The destination estimates the quality (for example SNR) of the direct links: source to destination and relay to destination using known techniques based on the use of reference signals. The quality of the source-source, relay-relay and source-relay links is estimated by the sources and the relays using for example the reference signals. The sources and the relays transmit the average qualities of the links to the destination. This transmission takes place before the initialization phase. Since only the average value of the quality of a link is taken into account, it is refreshed on a long time scale, that is to say over a time that makes it possible to average fast variations (fast fading) of the channel. This time is of the order of the time necessary to travel several tens of wavelengths of the frequency of the transmitted signal for a given speed of a node in the system. The initialization phase takes place for example every 200 to 1000 frames. The destination returns the initial throughputs that it has determined to the sources by way of feedback. The initial throughputs remain constant between two instances of the initialization phase.

In the first phase, the M sources successively transmit their message during the M time slots using, respectively, modulation and coding schemes that are determined from the initial throughputs. During this phase, the number N₁ of uses of the channel (channel use i.e. resource element according to the terminology of the 3GPP) is fixed and identical for each of the sources.

The mutually independent sources, during the first phase, broadcast their coded information sequences in the form of messages for the attention of a single recipient. Each source broadcasts its messages at its initial throughput. The destination communicates, to each source, its initial throughput via control channels having very limited throughput. Thus, during the first phase, the sources each transmit their respective message in turn during time slots that are each dedicated to a source.

The sources other than the one transmitting and possibly the relays, of the “half-duplex” type, receive the successive messages from the sources and decode them.

In the second phase, the destination selects, for the current slot t, a single node taken from among the sources and relays to cooperate. This node randomly selects the source it assists from the one it has correctly decoded and that the destination has not yet decoded correctly by transmitting a redundancy of the message from that source.

This phase lasts for at most Tₘₐₓ time slots. During this phase, the number N₂ of channel uses is fixed and identical for each of the nodes (sources and relays) that is selected.

This article teaches control signals that consist, for the destination, in broadcasting M bits that indicate its set of correctly decoded sources in the slot t−1, for the nodes that have correctly decoded a source that the destination has not yet correctly decoded to transmit a signal on a dedicated unicast channel and for the others to remain silent and finally for the destination to broadcast the result of its selection according to the retained selection strategy.

Although these exchanges limit the overhead linked to signaling while allowing maximization of the average spectral efficiency (utility metric) within the system under consideration subject to the constraint of compliance with an individual quality of service (QOS) per source, it may be desirable to further limit the signaling overhead while making the best use of the time for transmitting a frame.

The present invention meets this objective.

### Main Features of the Invention

The present invention relates to a method for transmitting a frame carrying messages intended for an OMAMRC telecommunication system having sᵢ sources i∈{1, . . . , M} L, possibly N≥ M≥2 relays L≥0, and a destination, N≥ M≥2, L≥0, the nodes operating in half-duplex mode, according to an orthogonal multiple-access scheme of the transmission channel between the N nodes with a maximum number of M+Tₘₐₓ time slots per transmitted frame, which are distributed between a 1^{st} phase and a 2^{nd} phase, 1≤Tₘₐₓ, the message from a source having been coded prior to transmission according to an incremental-redundancy coding that generates multiple redundancies, the 1^{st} phase comprises M slots respectively allocated to the successive transmissions of the M sources and the 2^{nd} phase comprises at least one retransmission slot for a transmission of nodes that have correctly decoded the same source sᵢ, which transmission is such that these nodes simultaneously transmit during the same retransmission slot the same redundancy of the message from the same source not yet correctly decoded by the destination, known as the source to assist. The method is such that it comprises:
at least one decoding control exchange between the destination and the nodes, such exchange enabling the destination to determine, for each of the sources, a quality of an equivalent channel that is based on a quality of the channels between the nodes that have correctly decoded a source i and the destination,
an estimation of a number of retransmission slots (xᵢ(0)) sufficient for the destination to decode a source (sᵢ) not yet correctly decoded that has been correctly decoded by at least one node based on the quality of an equivalent channel for that source between that at least one node and the destination and a throughput (Rᵢ) assigned to that source (sᵢ),
a selection by the destination of the sources to assist taking into account the estimated numbers (xᵢ(0)) of retransmission slots sufficient for the destination to decode the sources that have not yet been correctly decoded and a sum of throughputs (Rᵢ) assigned to the sources,
a number of retransmission slots per source defining a so-called authorized duration to assist a source during this authorized duration limited by a time remaining until Tₘₐₓ even if the estimated number of retransmission slots sufficient for this source is greater than the time remaining.

During a decoding control exchange between the source and the nodes, the nodes communicate their set of correctly decoded sources to the destination. If the destination has previously communicated its own set of correctly decoded sources, the transmission by the nodes may contain only their set of correctly decoded sources minus those already decoded correctly by the destination. Node transmission allows the destination to evaluate the quality of node-destination channels in order to estimate per source a sufficient number of retransmission slots for the destination to decode this source correctly. In light of these sufficient numbers of slots, the destination can then successively select the sources to assist, either randomly or in an orderly manner, from those whose sufficient number of slots is less than the time remaining before reaching Tₘₐₓ. Scheduling can be done by successively selecting the sources on the basis of the increasing sufficient numbers of slots.

Thus, while limiting the number of control exchanges between the source and the nodes during which the nodes communicate to the destination their set of correctly decoded sources, the invention provides an opportunity for the destination to decode a source even if the time remaining is less than the estimated sufficient number of retransmission slots for that source.

The destination successively selects this source for the authorized duration and at most for the time remaining until it decodes it correctly.

According to one embodiment of the invention, the method further comprises, if the time remaining is not zero, a decoding control exchange between the destination and the nodes so that the destination re-estimates a number of retransmission slots sufficient for the destination to decode a source i, this source having been assisted for the authorized duration but not yet decoded correctly by the destination.

The use of a source for the authorized duration without decoding success by the destination triggers a new decoding control exchange to update the estimated number of slots provided there is time left before reaching Tₘₐₓ. The method is stopped when all sources are correctly decoded by the destination or when the maximum time Tₘₐₓ is reached.

According to one embodiment of the invention, only the nodes that have correctly decoded the source i transmit a decoding indicator of this source i.

According to one embodiment of the invention, only the nodes that have correctly decoded the source i transmit their set of correctly decoded sources.

According to one embodiment of the invention, the nodes transmit at least their set of correctly decoded sources not yet correctly decoded by the destination.

According to one embodiment of the invention, the at least one decoding control exchange comprises a transmission by the nodes of at least their set of correctly decoded sources not yet correctly decoded by the destination, which is carried out at the beginning of the 2^{nd} phase.

According to one embodiment of the invention, the method further comprises a comparison between a sum of estimated numbers of retransmission slots to assist the destination in decoding sources not yet correctly decoded and a number of time slots remaining during the 2^{nd} phase to assist the destination in correctly decoding one or more sources.

According to this embodiment, the method adds at least two estimated numbers and compares the result with the time remaining. If the result of the addition is less than the time remaining, all sources involved in the addition may be assisted during the 2^{nd} phase.

According to one embodiment of the invention, the comparison is updated after the correct decoding of a source by the destination.

Since the correct decoding of a source by the destination can occur before the end of the estimated sufficient number of retransmission slots, this embodiment allows another source to assist in benefiting from the time not used up.

According to one embodiment of the invention, the at least one decoding control exchange comprises a transmission by the nodes of at least their set of correctly decoded sources not yet correctly decoded by the destination and a transmission by the source of its set of correctly decoded sources.

According to one embodiment of the invention, a node sends only its set of correctly decoded sources not yet correctly decoded by the destination during the at least one decoding control exchange.

According to one embodiment of the invention, a node sends its set of correctly decoded sources during the at least one decoding control exchange.

According to one embodiment of the invention, the method further comprises a comparison between the estimated numbers of retransmission slots sufficient for the selection to take into account a scheduling of these estimated sufficient numbers of retransmission slots.

According to this embodiment, the estimated sufficient numbers of retransmission slots are classified according to their value. Moreover, preferably, the method first selects the source for which the estimated sufficient number of retransmission slots is the smallest. The same source is assisted for the duration corresponding to this estimated number or for a shorter duration if its correct decoding by the destination occurs before the end of the estimated number. The method thus successively considers the sources remaining to be decoded correctly.

According to one embodiment of the invention, the method further comprises a determination of a set of sources to assist taking into account the estimated sufficient numbers of retransmission slots and a time remaining before the end of the 2^{nd} phase.

According to one embodiment of the invention, the set of sources to assist contains all the undecoded sources when none of the sufficient numbers of retransmission slots is less than the time remaining.

The invention also relates to a communication device adapted for implementing a transmission method according to the invention.

Another subject of the invention is a system comprising M sources s₁, . . . , s_{M}, L relays r₁, . . . , r_{L} and a destination d, M≥2, L≥0, for implementing a transmission method according to the invention.

Another subject of the invention is each of the specific software applications on one or more information media, said applications containing program instructions suitable for implementing the transmission method when these applications are executed by processors.

Another subject of the invention is configured memories containing instruction codes corresponding respectively to each of the specific applications.

The memory may be incorporated into any entity or device capable of storing the program. The memory may be of ROM type, for example a CD-ROM or a microelectronic circuit ROM, or else of magnetic type, for example a USB key or a hard disk.

On the other hand, each specific application according to the invention may be downloaded from a server accessible on an Internet network.

The optional features presented above in the context of the transmission method may possibly apply to the software application and to the memory that are mentioned above.

### LIST OF THE FIGURES

Other features and advantages of the invention will become more clearly apparent on reading the following description of embodiments, which are given by way of simple illustrative and non-limiting examples, and the appended drawings, in which:

FIG. 1 is a diagram of an example of a so-called OMAMRC (Orthogonal Multiple-Access Multiple-Relay Channel) cooperative system described with reference to the prior art,

FIG. 2 is a diagram of a transmission cycle of a frame according to an exemplary implementation of the invention,

FIG. 3 is a diagram illustrating a decoding control exchange between the destination and the nodes, sources and relays, according to the invention.

FIG. 4 is a diagram illustrating a conditional decoding control exchange between the destination and the nodes, sources and relays, according to the invention, if the authorized duration to assist one source i from the multiple sources not yet decoded is not sufficient for a correct decoding by the destination and the maximum time Tₘₐₓ is not reached.

### DESCRIPTION OF PARTICULAR EMBODIMENTS

Channel use is the smallest granularity in terms of time-frequency resources defined by the system that allows transmission of a modulated symbol. The number of channel uses is linked to the available frequency band and to the transmission duration.

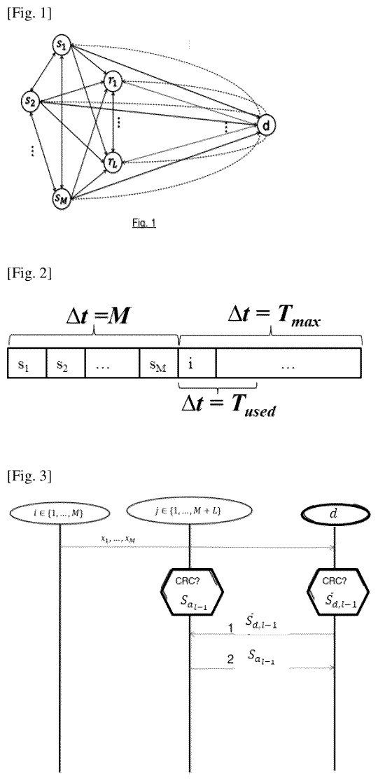

An OMAMRC system is illustrated by FIG. 1, which has already been described.

An OMAMRC system according to the invention comprises M sources that belong to the set of sources [symbol] ={s₁, . . . , s_{M}}, possibly L relays that belong to the set of relays [symbol] ={r₁, . . . , r_{L}}, and a destination d. By convention, it is considered that sᵢ=i∀i∈{1, . . . , M} and rᵢ=M+i∀i∈{1, . . . , L}, in other words it is possible to confuse a source and its index, and a relay and its index (offset by the value M of the number of sources). Each source of the set [symbol] communicates with the single destination using the other sources (user cooperation) and the relays that cooperate.

### Transmission Cycle of a Frame According to the Invention

A transmission cycle of a frame according to an exemplary implementation of the invention is illustrated by FIG. 2.

The method according to the invention distinguishes between two phases for each frame to be transmitted: a 1^{st} phase and a 2^{nd} phase. The transmission of a frame is possibly preceded by an additional phase known as the initial phase, during which the throughputs are allocated.

The M sources access the transmission channel according to an orthogonal time-division multiple access scheme during the 1^{st} phase. During the 2^{nd} phase, access to the transmission channel of the N nodes that include the M sources and possibly the L relays is considered orthogonal because in each retransmission slot the active nodes transmit the same redundancy of the same message from the same source i in parallel.

The N nodes operate in a half-duplex mode that allows them to listen without interference to transmissions from the other nodes. Sources can behave as a relay when they transmit not only their own message.

The CSIs of the links are assumed to be constant (slow fading hypothesis) during the transmission of a frame. From time to time, the destination allocates throughputs to the sources in light of the distribution of all channels (CDI: Channel Distribution Information). The throughput allocation is assumed not to change for several hundred frames, and it changes only with changes in CDI.

Each of the allocated throughputs unambiguously determines a modulation and coding scheme (MCS) or, conversely, each MCS determines a throughput. The allocated throughputs are returned from the destination to the sources via control channels having very limited throughput (shown in dotted lines in FIG. 1).

For the sake of simplifying the description, the following assumptions are made hereinafter on the OMAMRC system:
the sources, the relays and the destination are equipped with a single transmission antenna (or transmission antenna port);
the sources, the relays and the destination are equipped with a single reception antenna (or reception antenna port);
the sources, the relays and the destination are perfectly synchronized;
the sources are statistically independent (there is no correlation between them);
all of the nodes transmit at the same power;
use is made of a CRC code assumed to be included in the Kᵢ bits of information from each source i in order to determine whether or not the message associated with the bits of information is correctly decoded i∈ [symbol] ;
the links between the various nodes suffer from additive noise and fading. The fading gains are fixed during the transmission of a frame carried out for a maximum duration of M+Tₘₐₓ time slots, but may change independently from one frame to another. Tₘₐₓ≥1 is a parameter of the system;
the instantaneous quality of a channel/direct link at reception (CSIR Channel State Information at Receiver) is available at the destination, at the sources and at the relays;
the feedback is error-free (no error on the control signals/channels).

The following notations are used:
Rᵢ=Kᵢ/N₁ is a discrete variable representing the throughput of the source i provided by a link adaptation process implemented before the frames are transmitted,
T_{used} is the number of retransmission slots used during the 2^{nd} phase, T_{used}∈{1, . . . , Tₘₐₓ}; it corresponds to the number of transmissions during this phase; the time remaining is defined by Tₘₐₓ−T_{used},
α=N₂/N₁ is the ratio between the number of channel uses available in each time slot of the 2^{nd} phase and the number of channel uses available in each time slot of the 1^{st} phase,
S̅_{d,l} is the set of sources not correctly decoded by the destination at the end of the retransmission slot l, l∈{1, . . . , T_{used}},
S_{α}_{ₗ} is the set of sources correctly decoded by the node α∈ [symbol] ∪ [symbol] at the end of the retransmission slot l, l∈{1, . . . , T_{used}},
O_{i,t} is the fault (outage) indicator, which takes the value one when an individual fault event occurs and the value zero otherwise. O_{i,T}_{ₘₐₓ} represents the fault event of the source i i.e. the source is not decoded correctly at the end of the sending of a frame given that the maximum number of retransmission slots Tₘₐₓ has been reached without this source i being correctly decoded. The individual fault event O_{i,t} depends, in each retransmission slot t, on the mutual information of the nodes that have correctly decoded the source i,
I_{i,d} represents the mutual information between the source i∈{1, . . . , M} and the destination d,
J_{i,d}(l) represents the mutual information between the set of nodes assisting the source i and the destination in the retransmission slot l (it is considered an equivalent channel formed by the different channels between these nodes and the destination). By convention, J_{i,d}(0) is equal to I_{i,d}.

### Transmission of a Frame According to the Invention

During the first phase of the method, the sources i∈ [symbol] successively transmit, after coding, their message uᵢ containing Kᵢ bits of information uᵢ∈

$${𝔽}_{2}^{{K}_{i}}$$

, [symbol] ₂ being the two-element Galois body. The message uᵢ comprises a code of CRC type that makes it possible to check the integrity of the message uᵢ. The message uᵢ is coded according to the MCS determined by the allocated throughput. Given that the MCSs may be different between the sources, the lengths of the coded messages may be different between the sources. The coding uses an incremental redundancy code. The code word obtained is divided into successive redundancies. The incremental redundancy code may be systematic, and the bits of information are then included in the first redundancy. Whether or not the incremental redundancy code is systematic, it is such that the first redundancy is able to be decoded independently of the other redundancies. The incremental redundancy code may be created for example by way of a finite family of punctured linear codes with compatible rates or of codes with no rate that are modified so as to operate with finite lengths: raptor code (RC), rate compatible punctured turbo code (RCPTC), rate compatible punctured convolutional code (RCPCC), rate compatible low density parity check code (RCLDPC).

Transmission by a source conventionally comprises one or more reference signals. The destination estimates the channel and therefore its quality between each of the sources and the destination in a known manner by exploiting, for example, the reference signal or signals received.

Whether during the first or the second phase, when a node transmits, especially a source, the destination and the other nodes listen.

The destination, the sources, and the relays attempt to decode the redundancies received at the end of a time slot. The success of the decoding at each node is decided using the CRC. The destination and the nodes thus determine their set of correctly decoded sources in each slot.

The 2^{nd} transmission phase of the method comprises t={1, . . . , T_{used}} retransmission slots with the convention that t=0 corresponds to the last transmission slot of the first phase. The term retransmission associated with a slot is used in connection with the 2^{nd} phase to clearly indicate that any transmission during this phase of an n^{th} redundancy of the message from a source i occurs when this source i has already transmitted the 1^{st} redundancy of this same message during the 1^{st} phase.

Unlike the prior art, there is no decoding control exchange between the destination and the nodes in each retransmission slot: the destination does not systematically return in each retransmission slot its set of correctly decoded sources or an indication of a correct or incorrect decoding; the nodes do not systematically transmit in each retransmission slot their set of correctly decoded sources or an indication of their correct or incorrect decoding. The decoding control exchange for an update of the knowledge by the destination of the sets of sources correctly decoded by the nodes takes place at least once when t=1, i.e. at the beginning of the second phase. This exchange may take place in an equivalent manner at the end of the first phase.

During such an exchange, the nodes transmit to the destination their set of correctly decoded sources or at least their set of correctly decoded sources not yet decoded correctly by the destination. Transmission by a node conventionally comprises one or more reference signals.

The destination estimates the channel and therefore its quality between each of the nodes and the destination in a known manner by exploiting, for example, the reference signal or signals received during this exchange.

Thus, the nodes transmit to the destination their set of correctly decoded sources or at least their set of correctly decoded sources not yet decoded correctly by the destination at least once, i.e. at least during the last transmission slot, t=0 or equivalently during the 1^{st} retransmission slot, t=1.

On the other hand, in each retransmission slot, the destination selects a source known as the source to assist by using a broadcast control channel from the destination to the nodes. The nodes that have correctly decoded this source then transmit the same redundancy of the message from this source during this slot by using a data channel. Assisting a source means assisting the destination in decoding this source by transmitting through the nodes that have correctly decoded this source a redundancy of the message from this source during the 2^{nd} phase.

### Selection According to the Invention

The selection by the destination of a source to assist in each retransmission slot is explained below in support of FIG. 3, which illustrates a decoding control exchange between the destination and the nodes according to one embodiment. According to this embodiment, the destination returns to the nodes its set of correctly decoded sources and the nodes transmit their set of correctly decoded sources. According to another embodiment, the destination returns to the nodes its set of correctly decoded sources and the nodes transmit their set of correctly decoded sources not yet decoded correctly by the destination. According to another embodiment, the destination returns to the nodes a signal indicating an absence of correct decoding, NACK, and the nodes transmit their set of correctly decoded sources.

During the 2^{nd} phase, the destination alternately arranges the sources that have not yet been correctly decoded for a given number of successive transmissions in order to maximize the received sum throughput. A transmission, during a retransmission slot, to assist a source i corresponds to the transmission of the same redundancy version of its message by all nodes that have correctly decoded this source. Transmissions to assist a source i begin in the retransmission slot t_{s,i} and end when the source is decoded.

The individual fault event of the source i, for which the retransmission slots start at t_{s,i}, at the end of the retransmission slot t−1, O_{i,t-1}, can be expressed in the form:

$${O}_{i , t - 1} = \{ {R}_{i} > {I}_{i , d} + α {\sum }_{l = {t}_{s , i}}^{t - 1} {J}_{i , d} ( l ) \} \qquad ( 1 )$$

This expression reflects the fact that the source i is not decoded correctly in the retransmission slot t−1 if the throughput Rᵢ of the source is greater than the sum of the transmission capacities. This transmission capacity comprises the capacity of the channel between this source i and the destination that occurs during the 1^{st} phase and a sum weighted by a capacities of the equivalent channels that occur during the second phase from t_{s,i} to the retransmission slot t−1. In the retransmission slot l≥t_{s,i} of the second phase, an equivalent channel is considered for the source i. The equivalent channel considered in a retransmission slot l groups the channels between each of the nodes assisting the source i during that slot and the destination. The capacity of the channel between this source i and the destination is deduced from the quality of the channel, i.e. the mutual information lid between the source i∈{1, . . . , M} and the destination d. The capacity of the equivalent channel considered when the source i is assisted during the slot l is evaluated by the mutual information J_{i,d}(l) between the set of nodes that assist the source i in the retransmission slot l and the destination. This capacity is dependent on time l, since a node can benefit from transmissions to assist a source i during the 2^{nd} phase and correctly decode that source i from a retransmission slot of the 2^{nd} phase, whereas it had not decoded it at the end of the 1^{st} phase.

X(t) is defined as the number of retransmission slots elapsed up to the current slot (not inclusive) during the second phase since the last decoding control exchange between the destination and the nodes.

X^{m}(t) defines the value of X(t) that triggers a new exchange of sets of decoded sources. For example X^{m}(t)=2∀t∈{1, . . . , Tₘₐₓ} triggers an exchange of sets of decoded sources for tⱼ=1+2j with j∈

$$\{ 1 , … , ⌊ \frac{( {T}_{max} - 1 )}{2} ⌋ \} .$$

By convention, X^{m}(1)=0 triggers an exchange of sets of decoded sources at the beginning of the 2^{nd} transmission phase.

It is assumed that a source i is assisted over one or more consecutive retransmission slots starting with the retransmission slot t_{s,i}∈{1, . . . , Tₘₐₓ}. In each retransmission slot (time slot) t≥ t_{s,i}, and for the selected source i not yet decoded correctly by the destination, i∈S̅_{d,t-1}, the variable \hat{x}ᵢ(t) is defined according to the invention. This variable \hat{x}ᵢ(t) is defined as the maximum number (i.e. sufficient number) of retransmission slots for the destination to decode this source i (from and counting the retransmission slot tₛ), that is to say the source i is decoded no later than the end of the retransmission slot t+\hat{x}ᵢ(t)−1. This variable \hat{x}ᵢ(t) is estimated by the destination based on its knowledge of J_{i,d}(l)l∈{t_{s,i}, . . . t}. Let the set S′={t′₀, t′₁, . . . , t′_{N}} determined by X^{m}(t) be retransmission slots beginning with an exchange of sets of decoded sources. Let the set S={t₀, t₁, . . . , t_{M}} be retransmission slots beginning with an exchange of sets of decoded sources coinciding with the transmissions to assist the source i, i.e. t_{s,i}<t₀≤t₁≤ . . . ≤t_{M}.

If an exchange of sets of decoded sources took place before t_{s,i}, i.e. before the beginning of the selection of the source i to assist during the 2^{nd} phase, the destination knows Ĵ_{i,d}(t_{s,i})=J_{i,d}(t_{s,i})=J_{i,d}(1). It should be noted that an exchange of sets of decoded sources at the beginning of the 2^{nd} transmission phase informs the destination of J_{i,d}(t_{s,i}) for all sources. In point of fact, as the transmissions preceding t_{s,i} are linked to another source, they do not affect the number of nodes that have decoded the source i or J_{i,d}(t_{s,i}).

Otherwise, the destination knows only Ĵ_{i,d}(t_{s,i})=J_{i,d}(0)=I_{i,d} in order to estimate \hat{x}ᵢ(t) for t_{s,i}≤t<t₀. To simplify the notations, the source index i of t_{s,i} is omitted when it is obvious. For the retransmission slots tₛ≤t<t₀, the invention considers:

$${y}_{i} ( {t}_{s} ) = \frac{{R}_{i} - {I}_{i , d}}{α {\hat{J}}_{i , d} ( {t}_{s} )} \qquad ( 2 )$$

$$and$$

$${y}_{i} ( t ) = \frac{{y}_{i} ( {t}_{s} ) ( α {\hat{J}}_{i , d} ( {t}_{s} ) ) - α ( t - {t}_{s} ) \hat{{J}_{i , d}} ( {t}_{s} )}{α \hat{{J}_{i , d}} ( {t}_{s} )} , \qquad ( 3 )$$

the sufficient number of retransmission slots estimated by the destination from the retransmission slot t is:

$${\hat{x}}_{i} ( t ) = ⌈ {y}_{i} ( t ) ⌉ \qquad ( 4 )$$

where ┌q┐ represents the ceiling function that takes the integer value just greater than or equal to q, e.g. ┌2.3┐=3.

For t=t₀, an exchange of sets of decoded sources takes place, which allows the destination to evaluate J_{i,d}(t₀), as follows:

$${y}_{i} ( {t}_{0} ) = \frac{{y}_{i} ( {t}_{s} ) ( α {\hat{J}}_{i , d} ( {t}_{s} ) ) - α ( {t}_{0} - {t}_{s} ) {\hat{J}}_{i , d} ( {t}_{s} )}{α {J}_{i , d} ( {t}_{0} )} \qquad ( 5 )$$

$$with$$

$${\hat{x}}_{i} ( {t}_{0} ) = ⌈ {y}_{i} ( {t}_{0} ) ⌉ \qquad ( 6 )$$

More generally, for tⱼ<t≤tⱼ₊₁ j=0, . . . , M−1, it is possible to recursively construct yᵢ(t) as:

$${y}_{i} ( t ) = \{ \begin{matrix}\frac{{y}_{i} ( t - X ( t ) ) ( α {J}_{i , d} ( t - X ( t ) ) ) - α X ( t ) {J}_{i , d} ( t - X ( t ) )}{α {J}_{i , d} ( t - X ( t ) )} & {t}_{j} < t < {t}_{j + 1} \\ \frac{{y}_{i} ( t - X ( t ) ) ( α {J}_{i , d} ( t - X ( t ) ) ) - α X ( t ) {J}_{i , d} ( t - X ( t ) )}{α {J}_{i , d} ( t )} & t = {t}_{j + 1}\end{matrix} \qquad ( 7 )$$

or, equivalently:

$${y}_{i} ( t ) = \{ \begin{matrix}\frac{{y}_{i} ( {t}_{j} ) ( α {J}_{i , d} ( {t}_{j} ) ) - α ( t - {t}_{j} ) {J}_{i , d} ( {t}_{j} )}{α {J}_{i , d} ( {t}_{j} )} & {t}_{j} < t < {t}_{j + 1} \\ \frac{{y}_{i} ( {t}_{j} ) ( α {J}_{i , d} ( {t}_{j} ) ) - α ( {t}_{j + 1} - {t}_{j} ) {J}_{i , d} ( {t}_{j} )}{α {J}_{i , d} ( {t}_{j + 1} )} & t = {t}_{j + 1}\end{matrix} \qquad ( 8 )$$

always with:

$${\hat{x}}_{i} ( t ) = ⌈ {y}_{i} ( t ) ⌉ .$$

### Remark:

$${\hat{x}}_{i} ( t ) = ⌈ \frac{{y}_{i} ( {t}_{j} ) ( α {J}_{i , d} ( {t}_{j} ) ) - α ( t - {t}_{j} ) {J}_{i , d} ( {t}_{j} )}{a {J}_{i , d} ( {t}_{j} )} ⌉ = {\hat{x}}_{i} ( {t}_{j} ) - ( t - {t}_{j} ) \qquad ( 9 )$$

$${t}_{j} < t < {t}_{j + 1}$$

Between two decoding control exchanges, the number of retransmission slots sufficient to decode the source i is decremented on each transmission assisting the source i.

For t>t_{M}, it holds true that:

$${\hat{x}}_{i} ( t ) = ⌈ \frac{{y}_{i ( {t}_{M} ) ( a {J}_{i , d} ( {t}_{M} ) ) - α ( t - {t}_{M} ) {J}_{i , d} ( {t}_{M} )}}{a {J}_{i , d} ( {t}_{M} )} ⌉ \qquad ( 10 )$$

Finally, if no exchange of sets of decoded sources is performed either before or after tₛ, it holds true that:

$${\hat{x}}_{i} ( t ) = ⌈ \frac{{R}_{i} - {I}_{i , d} - α ( t - {t}_{s} ) {J}_{i , d} ( 0 )}{a {J}_{i , d} ( 0 )} ⌉ ∀ t \geq {t}_{s} \qquad ( 11 )$$

If a single exchange of sets of decoded sources is performed at the beginning of the 2^{nd} transmission phase then:

$${\hat{x}}_{i} ( t ) = ⌈ \frac{{R}_{ι} - {I}_{i , d} - α ( t - {t}_{s} ) {J}_{i , d} ( 1 )}{a {J}_{i , d} ( 1 )} ⌉ ∀ t \geq {t}_{s} \qquad ( 12 )$$

\hat{x}ᵢ(t) is the number of retransmission slots to assist the source i from the retransmission slot t inclusive sufficient for error-free decoding of the source i estimated by the destination based on its knowledge of J_{i,d}(l)∀l∈{t_{s,i} . . . , t+xᵢ(t)−1} . . . . The destination uses as an approximation of J_{i,d}(l) a previous value (closest known) Ĵ_{i,d}(l)=J_{i,d}(l′) with l′≤l, therefore Ĵ_{i,d}(l)≤J_{i,d}(l)∀l∈{t_{s,i} . . . , t+xᵢ(t)−1}.

The number of retransmission slots needed in practice

$${x}_{i}^{a} ( t )$$

requires knowledge of

$${J}_{i , d} ( l ) ∀ l ∈ \{ {t}_{s , i} , … , t + {x}_{i}^{a} ( t ) - 1 \} .$$

It is given by the smallest value of x such that:

$${R}_{i} \leq {I}_{i , d} + α {\sum }_{l = {t}_{s , i}}^{t + x - 1} {J}_{i , d} ( l ) \qquad ( 13 )$$

The estimate \hat{x}ᵢ(t) is the smallest value of x such that:

$${R}_{i} \leq {I}_{i , d} + α {\sum }_{l = {t}_{s , i}}^{t + x - 1} {\hat{J}}_{i , d} ( l ) \qquad ( 14 )$$

Like Ĵ_{i,d}(l)≤J_{i,d}(l), it holds true that \hat{x}ᵢ(t)≥xᵢ^{α}(t).

If Ĵ_{i,d}(l)=J_{i,d}(1), it holds true that:

$${\hat{x}}_{i} ( t ) = ⌈ \frac{{R}_{i} - α ( t - {t}_{s , i} ) {J}_{i , d} ( 1 )}{α {J}_{i , d} ( 1 )} ⌉ \qquad ( 15 )$$

In point of fact, the smallest positive integer such that:

$$x \geq \frac{R - {I}_{i , d} - α {J}_{i , d} ( 1 ) ( t - {t}_{s , i} )}{α {J}_{i , d} ( 1 )} \qquad ( 16 )$$

$$is :$$

$${\hat{x}}_{i} ( t ) = ⌈ \frac{{R}_{i} - α ( t - {t}_{s , i} ) {J}_{i , d} ( 1 )}{α {J}_{i , d} ( 1 )} ⌉ \qquad ( 17 )$$

Thus, it is certain that the fault event (outage) does not occur at t+\hat{x}ᵢ(t)−1. The source i is systematically decoded correctly by the destination at t+xᵢ(t)−1 if it is assisted \hat{x}ᵢ(t) times from the slot t inclusive.

The generalization of this demonstration in the case of multiple decoding exchanges is immediate.

It should be noted that the evaluation of the number of retransmission slots sufficient for a source i is the same regardless of t_{s,i} its retransmission slot chosen for the first transmission intended to assist that source during the 2^{nd} phase. In a given retransmission slot t, \hat{x}ᵢ(t) depends only on the number of transmissions nᵢ=t−t_{s,i} assisting the source i during the 2nd phase and before t. Thus, the notation xᵢ(nᵢ) denotes the required number of transmissions assisting the source i in light of the number of transmissions nᵢ that have assisted the source i (already completed) during the 2^{nd} phase. Subsequently, we use xᵢ to denote the counter of the number of remaining transmissions to assist the source i, this counter being initialized to xᵢ(0) and being decremented each time the source i is assisted without a decoding exchange. This counter is updated on each decoding control exchange in the retransmission slot l=tⱼ j=0, . . . , M−1 that identifies J_{i,d}(l).

If the estimate of xᵢ is such that there has been no previous transmission to assist the source i or such that xᵢ(0) is based solely on knowledge of the direct links and that for all sources i∈{1, . . . , M} the following inequality is satisfied:

$${T}_{max} \geq {\sum }_{i ∈ {\overline{S}}_{d , t - 1}} {x}_{i} \qquad ( 18 )$$

then all sources can be decoded without exchanging sets of decoded sources.

As all the sources can be decoded correctly by the destination in the time remaining, the method chooses the sources to assist successively, for example, and at random.

The method according to the invention is particularly useful when

$${T}_{max} < {\sum }_{i ∈ {\overline{S}}_{d , t - 1}}$$

xᵢ since it allows the destination to correctly decode an optimum number of sources by optimizing spectral efficiency while very severely limiting the signaling overhead by selecting the source to assist according to a certain strategy.

Furthermore, according to the invention, X^{m}(1)=0, i.e. a control exchange of sets of correctly decoded sources between the destination and the nodes occurs at least once, i.e. at the beginning of the 2^{nd} phase.

At t=1, i.e. at the beginning of the 2^{nd} phase, the method comprises a decoding control exchange between the destination and the nodes. The method determines the sufficient number of retransmission slots for the destination to decode the source i not yet decoded at the end of the 1^{st} phase in light of its assigned throughput Rᵢ:

$${\hat{x}}_{i} ( t ) = ⌈ \frac{{R}_{ι} - {I}_{i , t} - α ( t - {t}_{s , i} ) {\hat{J}}_{i , d} ( {t}_{s , i} )}{α {\hat{J}}_{i , d} ( {t}_{s , i} )} ⌉ ∀ t \geq {t}_{s} \qquad ( 19 )$$

with:

$${\hat{x}}_{i} ( {t}_{s , i} ) = {x}_{i} ( 0 ) = ⌈ \frac{{R}_{i} - {I}_{i , d}}{α {\hat{J}}_{i , d} ( {t}_{s , i} )} ⌉ \qquad ( 20 )$$

or, again with nᵢ=t−t_{s,i},

$${\hat{x}}_{i} ( t ) = {x}_{i} ( {n}_{i} ) = ⌈ \frac{{R}_{i} - {I}_{i , d} - α {n}_{i} {\hat{J}}_{i , d} ( {t}_{s , i} )}{α {\hat{J}}_{i , d} ( {t}_{s , i} )} ⌉ = {x}_{i} ( 0 ) - {n}_{i} \qquad ( 21 )$$

with nᵢ the number of transmissions already performed to assist the source i. Following the decoding control exchange between the destination and the nodes at t=1, the destination knows Ĵ_{i,d}(t_{s,i})=J_{i,d}(t_{s,i})=J_{i,d}(1). Without decoding control exchange at t=1, the destination is based on Ĵ_{i,d}(t_{s,i})=J_{i,d}(0)=I_{i,D}, i.e. on knowledge of the direct link between the source i and the destination.

Channel estimation between the source i and the destination is performed, for example, on the basis of the reference signals transmitted by the source i when transmitting during the first phase. Since channels are assumed to be invariant during a frame, this value is independent of the transmission or retransmission slot. This knowledge of the quality of the channel between the source i and the destination allows the destination to estimate mutual information I_{i,d} representative of this quality and therefore of the capacity of the channel.

In the second phase, the estimation of the channel between the node j∈{1, . . . , M+L} and the destination is performed, for example, based on a reference signal transmitted by the node j during a control exchange in the course of which it transmits its set or a subset of this set of correctly decoded sources. This knowledge of the quality of the channel between the node j and the destination in the slot t=1 allows the destination to estimate mutual information J_{i,d}(1) representative of the quality of the equivalent channel between all nodes that have decoded the source i and the destination.

For t>1 the method considers each transmission to lead to mutual information αJ_{i,d}(1) so that \hat{x}ᵢ(t) decreases on the basis of the number of transmissions performed to assist the source i.

According to the invention, the destination selects the source t to assist for each retransmission slot i.

In each retransmission slot t and before selection, the remaining number of retransmission slots Tₐᵥ is: Tₐᵥ=Tₘₐₓ−T_{used}·A t=0, T_{used}=0.

The selection is determined in order to maximize spectral efficiency. The maximization of spectral efficiency can be expressed in the form of the determination of the subset Â taken from among the set P(S̅_{d,t-1}) of possible subsets A of sources not yet decoded correctly by the destination in the slot preceding the current slot t leading to the largest sum of the throughputs of the sources and such that the sources of this subset Â can be decoded in the time remaining, Tₐᵥ i.e. such that the time remaining is greater than or equal to the sum of the number of retransmission slots sufficient to decode each of the sources in this subset Â:

$$Â = arg {max}_{A ∈ P ( {\overline{S}}_{d , t - 1} )} \times {\sum }_{i ∈ A} {R}_{i} such that {\sum }_{i ∈ A} {x}_{i} \leq {T}_{a ν} \qquad ( 22 )$$

P(S̅_{d,t-1}) is called the power set of S̅_{d,t-1}.

The method then successively considers each source i in this subset Â.

For each considered source i of Â, the destination transmits the indication of selection of the source i to the nodes in the retransmission slot t.

The nodes that have correctly decoded this source i transmit the same redundancy during this slot t to assist in the decoding of the source i by the destination.

The destination repeats transmission of the indication of selection of the same source i until the destination correctly decodes that source. The number of retransmission slots that have elapsed before correct decoding is at most equal to xᵢ(0).

In a particularly effective embodiment, if the destination correctly decodes the source i before the number xᵢ(0) of retransmission slots has elapsed, it considers the next source of the subset Â as soon as that source i is correctly decoded. This can occur when the set of sources that has been correctly decoded by a node changes to include the source i during the xᵢ(0) retransmission slots. Thus, this node becomes active during transmission in the slot l of a redundancy for the source i, which leads to an increase in the mutual information J_{i,d}(l)>J_{i,d}(1).

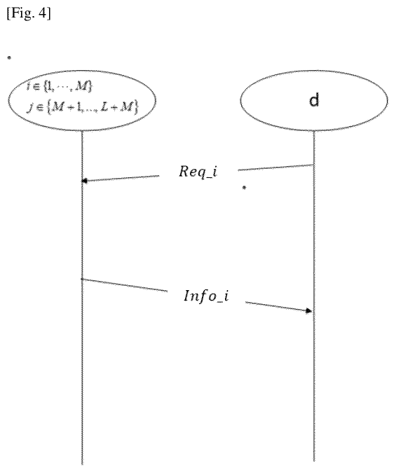

According to the invention, an authorized duration Nₘₐₓ is parametrized to assist one or more sources that have not yet been decoded correctly by the destination and for which the sufficient number of retransmission slots is greater than the time remaining. The method may include a conditional decoding control exchange if the authorized duration to assist one source i from the multiple sources not yet decoded is not sufficient for correct decoding by the destination and the maximum time Tₘₐₓ is not reached. Such a decoding control exchange is illustrated by FIG. 4.

The destination d requires an update, Req_i, for the source i. In response, the nodes transmit Info_i.

According to a first embodiment, this decoding control exchange is such that only the nodes that have correctly decoded the source i transmit their set of correctly decoded sources, Info_i=S_{α,l-1} for a node α∈ [symbol] ∪ [symbol] provided that i∈S_{α,l-1}.

According to another embodiment, this decoding control exchange between the destination and the nodes is such that only the nodes that have correctly decoded the source i transmit not their complete set of decoded sources but a decoding indicator Info_i of this source i. This embodiment consumes less bandwidth of the signaling channel than the previous embodiment.

According to another embodiment, only the nodes that have correctly decoded the source i during the second phase, known as the retransmission phase, transmit a decoding indicator Info_i of this source i. In point of fact, the exchange of sets of decoded sources at the beginning of the second phase identifies the nodes that have been able to decode the source i at the end of the first phase

This embodiment consumes the least bandwidth of the signaling channel.

According to another embodiment, this decoding control exchange between the destination and the nodes is such that all the nodes transmit their set of correctly decoded sources, Info_i=S_{α,l-1} for all the nodes α∈ [symbol] ∪ [symbol] . This embodiment consumes more bandwidth for the signaling channel between the nodes and the destination than the previous two embodiments but is simpler for the nodes.

Whatever the embodiment, at the end of the exchange the destination can re-estimate, i.e. update, the sufficient number of retransmission slots to decode the source i. If the re-evaluated number of retransmission slots does not exceed Tₘₐₓ then the source i continues to be assisted until it is decoded without error by the destination, otherwise the destination can switch to another source and remove the source i from the set of sources that can be assisted during the remaining retransmission slots. At the end of the decoding control exchange, the destination can therefore update a set of sources to assist in the time remaining. If the sufficient number updated for the source i exceeds the time remaining, another source not yet decoded correctly may be given preference.

### Exemplary Implementation

The following description of an embodiment of the invention is illustrated using an implementation by an OMAMRC system having M=4 sources, S={1, 2, 3, 4}, L=3 relays, R={5, 6, 7}, and a destination. The parameter Tₘₐₓ is fixed at 8.

At the beginning of the 2^{nd} phase, i.e. t=1, the sets of sources correctly decoded by the nodes are as follows:

$${S}_{1 , 0} = \{ 1 \} , {S}_{2 , 0} = \{ 2 \} , {S}_{3 , 0} = \{ 3 \} , {S}_{4 , 0} = \{ 4 \} , {S}_{5 , 0} = \{ 2.3 \} , {S}_{6 , 0} = \{ 1 , 2 , 3 \} , {S}_{7 , 0} = ϕ , {S}_{d , 0} = ϕ .$$

In other words, the sources 1, 2, 3, 4 and the relay 7 have not yet decoded anything correctly at the end of the 1^{st} phase, but, as a source knows its own message, its set contains at least that message. The relay 5 has correctly decoded the sources 2 and 3 and the relay 6 has correctly decoded the sources 1, 2 and 3 at the end of the 1^{st} phase. The destination d has not yet decoded anything correctly and S̅_{d,0}≠ϕ at the end of the 1^{st} phase.

During the 2^{nd} phase, determination, by the destination, of the set of sources Â to assist is carried out, for example, according to the algorithm in appendix A.

During the 2^{nd} phase, selection of the source i to assist from the set Â in each retransmission slot is carried out, for example, according to the algorithm in annex B, which can be used since S̅_{d,0}≠ϕ.

### Flow of the Algorithm in Annex B:

Step 0. Initialization: t=0, Tₐᵥ=Tₘₐₓ, Nᵢ=0 ∀i∈S̅_{d,t}, Nₘₐₓ; F=ϕ

According to the example the time remaining is initialized to 8, i.e. Tₐᵥ=8, Nᵢ=0 for all sources since no source has yet been assisted, F=ϕ, Nₘₐₓ=3 the authorized duration for a source i even if xᵢ exceeds the time remaining.

Step 1. The destination determines the estimate of the number of slots needed xᵢ for the destination to decode a source i that has not yet been decoded based on knowledge of mutual information of the source i destination link and of a throughput Rᵢ assigned to that source i. The destination therefore calculates xᵢ for everything i∈S̅_{d,0}. The method moves to the 2^{nd} phase, i.e. t=1.

According to the example, the variables xᵢ have the following values in light of the direct source-destination links:

$${x}_{1} = 6 , {x}_{2} = 2 , {x}_{3} = 3 , {x}_{4} = 12$$

The throughputs Rᵢ have the following values:

$${R}_{1} = {1}_{,} {R}_{2} = 2 , {R}_{3} = 3 , {R}_{4} = 4$$

Step 2. t=1, initialization of the retransmission slot known as the current slot. According to annex B, this step is associated with the beginning of the 2^{nd} phase.

Step 3. If

$${T}_{av} < {\sum }_{i}^{M} {x}_{i} {1}_{\{ i ∈ {\overline{S}}_{d , 0} \}} ,$$

i.e. the time remaining is less than the sum of the xᵢ of the sources not yet correctly decoded by the destination, then the method performs steps 4-6, otherwise it moves to step 7.

According to the example, the sum of the xᵢ exceeds the time remaining: 6+2+3+12=23>Tₐᵥ=Tₘₐₓ=8 and so the method performs steps 4-6 before moving to step 7.

Step 4. A decoding control exchange occurs between the destination and the nodes.

During this exchange, the nodes transmit their set of correctly decoded sources or only their set of correctly decoded sources that are not yet correctly decoded by the destination, however.

According to the example, the sources and the relays respectively send their set of correctly decoded sources: S_{1,0}={1}, S_{2,0}={2}, S_{3,0}={3}, S_{4,0}={4}, S_{5,0}={2.3}, S_{6,0}={1, 2, 3}, S_{7,0}=ϕ.

Step 5. For a source i that has not yet been correctly decoded by the destination, the destination updates the estimate of the xᵢ using the quality of the equivalent channel considered to be the aggregation of the channels between the nodes that have correctly decoded this source and the destination.

According to the example, in light of the node-destination links, the variables xᵢ become:

$${x}_{1} = 6 , {x}_{2} = 1 , {x}_{3} = 3 , {x}_{4} = 12$$

Although x₂ has decreased, the sum of the xᵢ: 6+1+3+12=22 remains greater than the time remaining Tₐᵥ=Tₘₐₓ=8.

Step 6. End of if of step 3.

Step 7. The set of sources Â to assist at the beginning of the 2^{nd} phase is determined, according to the algorithm in annex A, by the destination in light of the xx and the throughputs Rᵢ assigned to the sources.

According to the example, the possible choices for Â that satisfy Σ_{i∈A}xᵢ≤Tₐᵥ are: {1}, {2}, {3}, {1, 2}, {1, 3}, {2, 3}. The set that leads to the maximum sum of the throughputs and that is determined according to the algorithm in annex A is Â={2, 3}. The flag returned by the call to algorithm B is equal to 1, i.e. the set Â={2, 3} is decodable since Σ_{i∈Â}xᵢ(t)=4≤8=Tₐᵥ.

Steps 8 to 30. 1^{st} “while” loop. The method repeats steps 8-30 to decode the frame while t≤Tₘₐₓ, while there is time remaining, i.e. Tₐᵥ>0 and while there remains a source i to decode in the set Â, i.e. Â≠ϕ.

According to the example, in the current slot t=1, Tₐᵥ=8, Â={2, 3}. t=1<Tₘₐₓ, Tₐᵥ=8>0 and Â={2, 3}≠Ø, so the method moves to step 9.

According to the example, in the current slot t=2, Â={3}. i=2, x₂=0, S_{d,1}={2}, N₂=1, Tₐᵥ=7, flag=1, Exit=0. t=2<Tₘₐₓ, Tₐᵥ=7>0 and Â={3}≠Ø, so the method moves to step 9.

According to the example, in the current slot t=4, S_{d,3}={2, 3}, i=3, x₃=1, N₃=2, Nₘₐₓ=3, Tₐᵥ=5, Â=S̅_{d,3}={1, 4}, flag=0, Exit=0. Tₘₐₓ=8. t=4<Tₘₐₓ, Tₐᵥ=5>0 and Â={1, 4}≠Ø, so the method moves to step 9.

According to the example, in the current slot t=5, i=1, x₁=5, N₁=1, S_{d,4}={2, 3}, Nₘₐₓ=3, Tₐᵥ=4, Â=S̅_{d,4}={1, 4}, flag=0, Tₘₐₓ=8, Exit=0. t=5<Tₘₐₓ, Tₐᵥ=4>0 and Â={1, 4}≠Ø, so the method moves to step 9.

According to the example, in the current slot t=6, i=1, x₁=4, N₁=2, S_{d,56}={2, 3}, Nₘₐₓ=3, Tₐᵥ=3, Â=S̅_{d,5}={1, 4}, flag=0, Tₘₐₓ=8. Exit=0. t=6<Tₘₐₓ, Tₐᵥ=3>0 and Â={1, 4}≠Ø, so the method moves to step 9.

According to the example, in the current slot t=7, x₁=2, N₁=3, S_{d,6}={2, 3}, Nₘₐₓ=3, Tₐᵥ=2, Â=S̅_{d,6}={1, 4}, flag=0, Tₘₐₓ=8. Exit=0. t=7<Tₘₐₓ, Tₐᵥ=2>0 and Â={1, 4}≠Ø, so the method moves to step 9.

Step 9. In the retransmission slot t, the destination selects the source i with the smallest xᵢ and moves to step 10.

According to the example, in the current slot t=1, Tₐᵥ=8, the destination selects the source 2, i.e. i=2, x₂=1. The method moves to step 10.

According to the example, in the current slot t=2, S_{d,1}={2}, Tₐᵥ=7, flag=1, Exit=0. The destination selects the source 3, i.e. i=3, x₃=3. The method moves to step 10.

According to the example, in the current slot t=4, S_{d,3}={2, 3}, Nₘₐₓ=3, Tₐᵥ=5, Â=S̅_{d,3}={1, 4}, flag=0, Exit=0, Tₘₐₓ=8. The destination selects the source 1 since x₁=6<x₄=12, i.e. i=1, x₁=6. The method moves to step 10.

According to the example, in the current slot t=5, i=1, x₁=5, N₁=1, S_{d,4}={2, 3}, Nₘₐₓ=3, Tₐᵥ=4, Â=S̅_{d,4}={1, 4}, flag=0, Tₘₐₓ=8, Exit=0. The destination selects the source 1 since x₁=5<x₄=12, i.e. i=1, x₁=5. The method moves to step 10.

According to the example, in the current slot t=6, i=1, x₁=4, N₁=2, S_{d,5}={2, 3}, Nₘₐₓ=3, Tₐᵥ=3, Â=S̅_{d,5}={1, 4}, flag=0, Tₘₐₓ=8. Exit=0. The destination selects the source 1 since x₁=4<x₄=12, i.e. i=1, x₁=4. The method moves to step 10.

According to the example, in the current slot t=7, i=1, x₁=2, N₁=3, S_{d,6}={2, 3}, Nₘₐₓ=3, Tₐᵥ=2, Â=S̅_{d,6}={1, 4}, flag=0, Tₘₐₓ=8. Exit=0. The destination selects the source 1 since x₁=2<x₄=12, i.e. i=1, x₁=2. The method moves to step 10.

Step 10. Initialization to 0 of the exit condition “Exit” of the 2^{nd} “while” loop and the method moves to step 11.

Steps 11-29. 2^{nd} “while” loop. The method repeats steps 11-29 while the source i is not correctly decoded by the destination, while time remains Tₐᵥ>0 and while the maximum time is not reached, i.e. t≤Tₘₐₓ and while the exit condition is not reached, i.e. “exit” equals 0.

According to the example, in the current slot t=1, i=2, N₂=0, x₂=1, Tₐᵥ=8, flag=1, Exit=0, S_{d,0}=Ø. i=2∉S_{d,0} and Exit=0 and Tₐᵥ=8>0 and t=1≤Tₘₐₓ, so the method moves to step 12.

According to the example, in the current slot t=2, Exit=0, i=3, x₃=3, S_{d,1}={2}, Tₐᵥ=7, flag=1. i=3∉S_{d,1} and Exit=0 and Tₐᵥ=7>0 and t=2≤Tₘₐₓ, so the method moves to step 12.

According to the example, in the current slot t=3, i=3, N₃=1, x₃=2 and Tₐᵥ=6, Nₘₐₓ=3, flag=1, Exit=0. S_{d,2}={2} i.e. i=3∉S_{d,2} and Exit=0 and Tₐᵥ=6>0 and t=3≤Tₘₐₓ, so the method moves to step 12.

According to the example, in the current slot t=4, i=1, x₁=6, S_{d,3}={2, 3}, Nₘₐₓ=3, Tₐᵥ=5, Â=S̅_{d,3}={1, 4}, flag=0, Tₘₐₓ=8, x₁=6. Exit=0. i=1∉S_{d,3} and Exit=0 and Tₐᵥ=5>0 and t=4≤Tₘₐₓ, so the method moves to step 12.

According to the example, in the current slot t=5, i=1, x₁=5, N₁=1, S_{d,4}={2, 3}, Nₘₐₓ=3, Tₐᵥ=4, Â=S̅_{d,4}={1, 4}, flag=0, Tₘₐₓ=8. Exit=0. i=1∉S_{d,4} and Exit=0 and Tₐᵥ=4>0 and t=5≤Tₘₐₓ, so the method moves to step 12.

According to the example, in the current slot t=6, i=1, x₁=4, N₁=2, S_{d,5}={2, 3}, Nₘₐₓ=3, Tₐᵥ=3, Â=S̅_{d,5}={1, 4}, flag=0, Tₘₐₓ=8. Exit=0. i=1∉S_{d,5} and Exit=0 and Tₐᵥ=3>0 and t=6≤Tₘₐₓ, so the method moves to step 12.

According to the example, in the current slot t=7, i=1, x₁=2, N₁=3, S_{d,6}={2, 3}, Nₘₐₓ=3, Tₐᵥ=2, Â=S̅_{d,6}={1, 4}, flag=0, Tₘₐₓ=8. Exit=0. i=1∉S_{d,6} and Exit=0 and Tₐᵥ=2>0 and t=7≤Tₘₐₓ, so the method moves to step 12.

According to the example, in the current slot t=8. i=1, x₁=1, N₁=4, S_{d,7}={2, 3}, Nₘₐₓ=3, Tₐᵥ=1, Â=S̅_{d,7}={1, 4}, flag=0, Tₘₐₓ=8. Exit=0. i=1∉S_{d,7} and Exit=0 and Tₐᵥ=1>0 and t=8≤Tₘₐₓ, so the method moves to step 12.

Step 12. In the retransmission slot t the destination returns the number of the source i to assist by way of the nodes as was selected in step 9.

According to the example, in the current slot t=1, i=2, the destination returns the number 2.

The nodes that have decoded the source 2 transmit the same redundancy in parallel. The method moves to step 13.

According to the example, in the current slot t=2<Tₘₐₓ=8, i=3, x₃=3, S_{d,1}={2}, Tₐᵥ=7, flag=1, Exit=0. The destination returns the number 3. The nodes that have decoded the source 3 transmit the same redundancy in parallel. The method moves to step 13.

According to the example, in the current slot t=3, i=3, N₃=1, x₃=2, Tₐᵥ=6, Nₘₐₓ=3, flag=1, Exit=0. S_{d,2}={2}. The destination returns the number 3. The nodes that have decoded the source 3 transmit the same redundancy in parallel. The method moves to step 13.

According to the example, in the current slot t=4, i=1, x₁=6, S_{d,3}={2, 3}, Nₘₐₓ=3, Tₐᵥ=5, Â=S̅_{d,3}={1, 4}, flag=0, Tₘₐₓ=8, x₁=6. Exit=0. The destination returns the number 1. The nodes that have decoded the source 1 transmit the same redundancy in parallel. The method moves to step 13.

According to the example, in the current slot t=5, i=1, x₁=5, N₁=1, S_{d,4}={2, 3}, Nₘₐₓ=3, Tₐᵥ=4, Â=S̅_{d,4}={1, 4}, flag=0, Tₘₐₓ=8. Exit=0. The destination returns the number 1. The nodes that have decoded the source 1 transmit the same redundancy in parallel. The method moves to step 13.

According to the example, in the current slot t=6, i=1, x₁=4, N₁=2, S_{d,5}={2, 3}, Nₘₐₓ=3, Tₐᵥ=3, Â=S̅_{d,5}={1, 4}, flag=0, Tₘₐₓ=8. Exit=0. The destination returns the number 1. The nodes that have decoded the source 1 transmit the same redundancy in parallel. The method moves to step 13.

According to the example, in the current slot t=7, i=1, x₁=2, N₁=3, S_{d,6}={2, 3}, Nₘₐₓ=3, Tₐᵥ=2, Â=S̅_{d,6}={1, 4}, flag=0, Tₘₐₓ=8. Exit=0. The destination returns the number 1. The nodes that have decoded the source 1 transmit the same redundancy in parallel. The method moves to step 13.

According to the example, in the current slot t=8. i=1, x₁=1, N₁=4, S_{d,7}={2, 3}, Nₘₐₓ=3, Tₐᵥ=1, Â=S̅_{d,7}={1, 4}, flag=0, Tₘₐₓ=8. Exit=0. The destination returns the number 1. The nodes that have decoded the source 1 transmit the same redundancy in parallel. The method moves to step 13.

Step 13. The method increments the value of the current retransmission slot, t←t+1, decrements the time remaining, Tₐᵥ←Tₐᵥ−1 and decrements the value of xᵢ since i has been assisted once by the nodes and increments the counter of the transmissions that have assisted the source i. The method moves to step 14 or exits the if loop and moves to step 20.

According to the example, for i=2, t=2, N₂=1, x₂=0 and Tₐᵥ=7. The following are unchanged: flag=1, Exit=0. S_{d,1}={2}, i.e. the source 2 is correctly decoded by the destination. The method moves to step 14.

According to the example, for i=3, t=3, N₃=1, x₃=2, Tₐᵥ=6, flag=1, Exit=0. S_{d,3}={2}, 3∉S_{d,2}, the method moves to step 20.

According to the example, for i=3, t=4, N₃=2, x₃=1, Tₐᵥ=5, flag=1, Exit=0. S_{d,3}={2, 3}, 3∈S_{d,3}, the method moves to step 14.

According to the example, for i=1, t=5, N₁=1, x₁=5, Tₐᵥ=4, Â=S̅_{d,4}={1, 4}, flag=0, Tₘₐₓ=8, Exit=0.

S_{d,4}={2, 3}, 1∉S_{d,4}, the method moves to step 20.

According to the example, for i=1, t=6, x₁=4, N₁=2, S_{d,5}={2, 3}, Tₐᵥ=3, Â=S̅_{d,5}={1, 4}, flag=0, Tₘₐₓ=8. Exit=0.

S_{d,5}={2, 3}, 1∉S_{d,5}, the method moves to step 20.

According to the example, for i=1, t=7, x₁=3, N₁=3, S_{d,6}={2, 3}, Tₐᵥ=2, Â=S̅_{d,6}={1, 4}, flag=0, Tₘₐₓ=8. Exit=0.

S_{d,6}={2, 3}, 1∉S_{d,6}, the method moves to step 20.

According to the example, for i=1, t=8, x₁=1, N₁=4, S_{d,7}={2, 3}, Nₘₐₓ=3, Tₐᵥ=1, Â=S̅_{d,7}={1, 4}, flag=0, Tₘₐₓ=8. Exit=0.

S_{d,78}={2, 3}, 1∉S_{d,7}, the method moves to step 20.

According to the example, for i=1, t=9, x₁=0, N₁=5, Nₘₐₓ=3, Tₐᵥ=0, Â=S̅_{d,8}={4}, flag=0, Tₘₐₓ=8. As x₁=0 then 1∈S_{d,8},

S_{d,8}={1,2,3}, i.e. the source 1 is decoded correctly by the destination. Since t=9>Tₘₐₓ, the method exits the loop 11-29 and moves to step 29, then to step 30.

Step 14. If the destination has correctly decoded the source i, then perform steps 15-19.

Otherwise the method moves to step 19.

According to the example, in the current slot t=2, the source i=2 is correctly decoded since x₂=0·S_{d,1}={2}, N₂=1, Tₐᵥ=7, flag=1, Exit=0. The method moves to step 15.

According to the example, in the current slot t=3, i=3, N₃=1, x₃=2, and Tₐᵥ=6, flag=1, Exit=0, the source 3 is not correctly decoded, S_{d,2}={2}, the method moves to step 19, then 20.

According to the example, in the current slot t=4, i=3, N₃=2, x₃=1 and Tₐᵥ=5, the source 3 is correctly decoded, S_{d,3}={2, 3}, flag=1. Nₘₐₓ=3, Exit=0. The method moves to step 15.

Step 15. The source i correctly decoded by the destination is removed from the set Â.

According to the example, in the current slot t=2, Â=Â\{2}={3}. i=2, x₂=0·S_{d,1}={2}, N₂=1, Tₐᵥ=7, flag=1, Exit=0. The method moves to step 16.

According to the example, in the current slot t=4, i=3, N₃=2, x₃=1, S_{d,3}={2, 3}, Nₘₐₓ=3 and Tₐᵥ=5, flag=1, Exit=0. Â=Â\{3}=Ø and the method moves to step 16.

Step 16. If the xᵢ slots have not been used up and the set Â does not contain all the sources not decoded correctly by the destination and flag=1, then the method performs steps 17-18.

Otherwise the method moves to step 18.

According to the example, in the current slot t=2, i=2, x₂=0, Â={3}·S_{d,1}={2}, N₂=1, Tₐᵥ=7, flag=1, Exit=0. The condition x₂>0 is not met although the conditions Â={3}≠S̅_{d,1}={1, 3, 4} and flag=1 are met, the method moves to step 18, then 19 then to step 29 then to step 30 since the source 2 is correctly decoded, i.e. the method loops back to step 8 with Â={3}, t=2, i=2, x₂=0, S_{d,1}={2}, N₂=1, Tₐᵥ=7, flag=1, Exit=0.

According to the example, in the current slot t=4, i=3, x₃=1, N₃=2, S_{d,3}={2, 3}, Nₘₐₓ=3 and Tₐᵥ=5, flag=1, Exit=0, Â=Ø. The condition x₃>0 is met, as are the conditions Â=ØS̅_{d,3}={1, 4} and flag=1, therefore the method performs steps 17-18.

Step 17. The method updates the set Â according to the algorithm of annex A with the up-to-date set of sources not decoded correctly by the destination and returns an updated value of flag.

According to the example, in the current slot t=4, i=3, x₃=1, N₃=2, S_{d,3}={2, 3}, Nₘₐₓ=3 and Tₐᵥ=5, flag=1, Exit=0, Â=Ø, the algorithm of annex A with (5, S̅_{d,3}) is used to update Â and flag.

According to the algorithm of annex A, since Σ_{i=1,4}xᵢ=6+12=18>Tₐᵥ=5 and x₁=6>5 and x₄=12>5, i.e. there is no subset that has a sum of xᵢ less than the time remaining, it holds true that: Â=S̅_{d,3}={1, 4} and flag=0, i.e. Â=S̅_{d,3}={1, 4} is a non-decodable set.

The method moves to step 18, then 19, then 20 with t=4, i=3, x₃=1, N₃=2, Nₘₐₓ=3, Tₐᵥ=5, Â=S̅_{d,3}={1, 4}, flag=0, Exit=0.

Step 18. End of if of step 16. The method moves to step 19.

Step 19. End of if of step 14. The method moves to step 20.

According to the example, in the current slot t=3, N₃=1, x₃=2 and Tₐᵥ=6, flag=1, Exit=0, S_{d,2}={2}. The method moves to step 20.

Step 20. If the destination has not correctly decoded the source i and flag=0 and Nᵢ=Nₘₐₓ, then perform steps 21-28. Otherwise the method moves to step 28.

According to the example, in the current slot t=3, i=3, N₃=1, x₃=2, S_{d,2}={2} and Tₐᵥ=6, flag=1, Exit=0. i∉S_{d,2} and Exit=0 but N₃<Nₘₐₓ, so the method moves to step 28.

According to the example, in the current slot t=4, S̅_{d,3}={1, 4}, i=3, x₃=1, N₃=2, Tₐᵥ=5, Â=S̅_{d,3}={1, 4}, flag=0, Exit=0. 3∈S_{d,3}, so the method moves to step 28.

According to the example, in the current slot t=5, i=1, x₁=5, N₁=1, S_{d,4}={2, 3}, Tₐᵥ=4, Â=S̅_{d,4}={1, 4}, flag=0, Tₘₐₓ=8, Exit=0. 1∉S_{d,4} and flag=0 but N₁≠Nₘₐₓ, so the method moves to step 28.

According to the example, in the current slot t=6, i=1, x₁=4, N₁=2, S_{d,5}={2, 3}, Tₐᵥ=3, Â=S̅_{d,5}={1, 4}, flag=0, Tₘₐₓ=8. Exit=0. 1∉S_{d,5} and flag=0 but N₁≠Nₘₐₓ, so the method moves to step 28.

According to the example, for i=1, t=7, x₁=3, N₁=3, S_{d,6}={2, 3}, Tₐᵥ=2, Â=S̅_{d,6}={1, 4}, flag=0, Tₘₐₓ=8. Exit=0. 1∉S_{d,6} and flag=0 and N₁=Nₘₐₓ, then the method performs steps 21-28.

According to the example, for i=1, t=8, x₁=1, N₁=4, S_{d,7}={2, 3}, Tₐᵥ=1, Â=S̅_{d,7}={1, 4}, flag=0, Tₘₐₓ=8. Exit=0. 1∉S_{d,7} and flag=0 and N₁>Nₘₐₓ, so the method moves to step 29.

Step 21. A decoding control exchange occurs between the destination and the nodes.

During this exchange, the nodes transmit their set of correctly decoded sources or only their set of correctly decoded sources that are not yet correctly decoded by the destination, however. The method then moves to step 22.

According to the example, in the current slot t=7, there is a control exchange and the method moves to step 22.

Step 22. For a source i that has not yet been correctly decoded by the destination, the destination updates the estimate of the xᵢ using the quality of the equivalent channel considered to be the aggregation of the channels between the nodes that have correctly decoded this source and the destination. The method moves to step 23.

According to the example, in the current slot t=7, N₁=3, S_{d,6}={2, 3}, Tₐᵥ=2, Â=S̅_{d,6}={1, 4}, flag=0, Tₘₐₓ=8. Exit=0. After update: x₁=2, x₄=12. The method moves to step 23.

Step 23. If xᵢ>Tₐᵥ, then the method performs steps 24-27.

According to the example, in the current slot t=7, x₁=2, N₁=3, S_{d,6}={2, 3}, Nₘₐₓ=3, Tₐᵥ=2, Â=S̅_{d,6}={1, 4}, flag=0, Tₘₐₓ=8. Exit=0. x₁=2+Tₐᵥ, so the method moves to step 27.

Step 24. The source i is included in the list F of sources that are no longer assisted.

Step 25. Update the set Â with the set of sources not yet decoded by the destination minus the content of F.

Step 26. Initialization to 1 of the exit condition “Exit” of the 2^{nd} “while” loop and the method moves to step 27.

Step 27. End of if of step 23, the method moves to step 28.

Step 28. End of if of step 20. The method moves to step 29.

Step 29. End of while loop of step 11. The method loops back to step 11 if the source i has not been decoded and exit=0 and t≤Tₘₐₓ otherwise the method moves to step 30.

According to the example, in the current slot t=3, i=3, N₃=1, x₃=2, Tₐᵥ=6, S_{d,2}={2}, flag=1, Exit=0. The method loops back to step 11.

According to the example, in the current slot t=4, S_{d,3}={2, 3}, i=3, x₃=1, N₃=2, Tₐᵥ=5, Â=S̅_{d,3}={1, 4}, flag=0, Exit=0. 3∈S_{d,3}, so the method moves to step 30.

According to the example, in the current slot t=8. i=1, x₁=1, N₁=4, S_{d,7}={2, 3}, Tₐᵥ=1, Â=S̅_{d,7}={1, 4}, flag=0, Tₘₐₓ=8. Exit=0. 1∉S_{d,7} and Exit=0 and t≤Tₘₐₓ then the method loops back to step 11.

Step 30. End of while loop of step 8.

According to the example, in the current slot t=4, S_{d,3}={2, 3}, i=3, x₃=1, N₃=2, Tₐᵥ=5, Â=S̅_{d,3}={1, 4}, flag=0, Exit=0. t=4≤Tₘₐₓ=8 and Â≠Ø then the method loops back to step 8.

According to the example, in the current slot t=5, i=1, x₁=5, N₁=1, S_{d,4}={2, 3}, Tₐᵥ=4, Â=S̅_{d,4}={1, 4}, flag=0, Tₘₐₓ=8, Exit=0. t=5≤Tₘₐₓ=8 and Â≠Ø then the method loops back to step 8.

According to the example, in the current slot t=6, i=1, x₁=4, N₁=2, S_{d,5}={2, 3}, Tₐᵥ=3, Â=S̅_{d,5}={1, 4}, flag=0, Tₘₐₓ=8. Exit=0. t=6≤Tₘₐₓ=8 and Â≠Ø then the method loops back to step 8.

According to the example, in the current slot t=7, i=1, x₁=2, N₁=3, S_{d,6}={2, 3}, Tₐᵥ=2, Â=S̅_{d,6}={1, 4}, flag=0, Tₘₐₓ=8. Exit=0. t=7≤Tₘₐₓ=8 and Â≠Ø then the method loops back to step 8.

According to the example, in the current slot t=8. i=1, x₁=1, N₁=4, S_{d,7}={2, 3}, Tₐᵥ=1, Â=S̅_{d,7}={1, 4}, flag=0, Tₘₐₓ=8. Exit=0. Â≠Ø and t=8=Tₘₐₓ then the method loops back to step 8.

According to the example, in the current slot t=9, the loop 8-30 is terminated. Transmission of the frame is interrupted; there is a decoding fault (outage event) of the source 4. The method moves to transmission of the next frame.

Thus, according to the invention, the absence of correct decoding of the source 1 although Nₘₐₓ is reached (step 20) triggers a decoding control exchange (step 21) to update the determination of the xᵢ and check if x₁ has become less or greater than the time remaining.

In a 1^{st} scenario taken into account in the example above, in step 22 x₁ is considered equal to 2=Tₐᵥ=2, the time remaining. As a result, the source 1 is not added to the list F and the set Â={1, 4} remains unchanged. The destination then selects the source until it is decoded or Tₘₐₓ is reached.

In another scenario, in step 22 x₁ is considered equal to 3>Tₐᵥ=2, the time remaining. As a result, the source 1 is added to the list F, so F={1} and the set Â is updated: Â=S̅_{d}\F={4} and the variable exit=1. At the end of step 30, the process loops back to step 8. The destination selects i=argmin_{i∈Â}xᵢ={4}. The loop 11-29 is interrupted either when the source 4 is decoded correctly or when t>Tₘₐₓ (since Nₘₐₓ=3>Tₐᵥ=2). In this case:
the source 4 is assisted during the 7^{th} slot (if the decoding is correct, transmission of the frame is interrupted),
the source 4 is assisted during the 8^{th} slot (whether or not the decoding is correct, transmission of the frame is interrupted at the end of the slot).

### Annex A

Determination of the set Â of sources to assist:

TABLE 1
Calculation of (Â, flag) = Â#2(Tₐᵥ,S̅_{d})

| | |
|---|---|
| 1. \| if (S̅_{d} = ϕ) then | |
| 2. \| Â = ϕ | If there is no further source to decode |
| \| | Â is the empty set |

|

3. | $else if ( {T}_{av} > {\sum }_{i}^{M} {x}_{i} {1}_{\{ iϵ {\overline{S}}_{d} \}} )$

|

| | |
|---|---|
| 4. \| Â ← S̅_{d} | If there are enough remaining |
| \| | retransmission slots (rounds) then Â |
| \| | includes the entire set of sources not |
| \| | decoded by the destination. Â is a |
| \| flag = 1 | “decodable” set, so: |
| \| | flag = 1 |
| 5. \| else | |

|

| | |
|---|---|
| 6. \| $\hat{A} ← arg {{max}_{Aϵ P ( \overline{S}}}_{d )} {\sum }_{iϵA} {R}_{i}$ | Â includes the set having the highest sum of throughputs and meeting the |
| \| such that Σ_{i∈A} xᵢ (t) ≤ Tₐᵥ) | condition of the number of |
| \| | retransmission slots remaining. |
| \| flag = 1 | Â is a “decodable” set, so: |
| \| | flag = 1 |
| \| IfÂ = Ø then | If no source subset has a sum of xᵢ less |
| \| Â ← S̅_{d} | than the time remaining, the function |
| \| | returns the complete set of sources that |
| \| | have not been correctly decoded. |
| \| flag = 0 | Â is a non-“decodable” set, i.e. no |
| \| | source can be decoded correctly before |
| \| | Tₘₐₓ with the known xᵢ => flag = 0 |
| \| End if | |
| 7. \| End if | |

### Annex B, Selection Strategy Algorithm:

TABLE 2

| | |
|---|---|
| 0. t ← 0; Tₐᵥ < Tₘₐₓ; Nᵢ = 0 ∀ i ∈ S̅_{d,t}; Nₘₐₓ; | End of the 1^{st} phase, i.e. t |
| F = ϕ | initial = 0, Tₐᵥ remaining number |
| | of slots initialized to Tₘₐₓ, |
| | Nₘₐₓ is set, F the list of sources |
| | that the destination cannot assist |
| | is initialized to the empty set, Nᵢ |
| | counter initialized to 0 |
| 1. Calculates xᵢ for everything i ∈ S̅_{d,0} | xᵢ is estimated on the basis of |
| | the direct source-destination |
| | links at the end of the 1^{st} phase |
| 2. t ← 1 | t is initialized to 1, beginning of |
| | the 2^{nd} phase |
| 3. \| $If ( {T}_{av} < {\sum }_{i}^{M} {x}_{i} {1}_{\{ iϵ {\overline{S}}_{d , 0} \}} ) then$ | If not enough retransmission slots (rounds) to decode all |
| \| | sources then do steps 4-6 |
| \| | |
| 4. \| The nodes send their set of correctly | The destination requires a |
| \| decoded sources, S_{a,t-1} | decode control exchange |
| 5. \| Update of xᵢ for everything i ∈ S̅_{d,t-1} | For any source not yet correctly |
| \| | decoded by the destination, xᵢ is |
| \| | estimated on the basis of the |
| \| | equivalent nodes-destination |
| \| | channel |
| \| | |
| 6. \| End of if | |
| | Determine the set Â at the |
| 7. Calculation (Â, flag) = A#2(Tₐᵥ,S̅_{d,t-1}) | beginning of the 2^{nd} phase |
| | according to annex A |
| 8. \| While (t ≤ Tₘₐₓ, Tₐᵥ > 0 and Â ≠ ϕ) do | Decoding of the frame is |
| \| | stopped at Tₘₐₓ or when Â is |
| \| | the empty set |
| 9. \| $Selection of the source i ← {argmin}_{i ∈ \hat{A}} {x}_{i}$ | The destination selects from the set Â the source i with the |
| \| | smallest xᵢ. |
| 10. \| Exit = 0 | Initialize the exit condition for |
| \| | the 2^{nd} “while” loop |
| 11. \| \|While (i ∉ S_{d,t-1} and Exit = 0 and t ≤ | The destination decodes the |
| \| \|Tₘₐₓ ) do | source i until it has decoded it |
| \| \| | correctly and the max time has |
| \| \| | been reached and the exit |
| \| \| | condition has been reached |
| 12. \| \| The destination requires the nodes to | The nodes that have correctly |
| \| \| assist the source i | decoded the source i transmit |
| \| \| | the same redundancy in parallel |
| 13. \| \| t ← t + 1; Tₐᵥ ← Tₐᵥ − 1; xᵢ < xᵢ ← 1; | Increment the current round t, |
| \| \| Nᵢ ← Nᵢ + 1; | decrement the number of rounds |
| \| \| | remaining, decrement xᵢ since i |
| \| \| | has been assisted once, |
| \| \| | increment the counter Nᵢ. |
| 14. \| \| \| if (i ∈ S_{d,t-1}) then | if i is decoded then do steps 15- |
| \| \| \| | 19 |
| 15. \| \| \| Â ← Â \ {i} | remove i from Â |
| 16. \| \| \| \| if (xᵢ) > 0 and Â ≠ S̅_{d,t-1} and | If i has been decoded before xᵢ |
| \| \| \| \| flag = 1) then | expires and Â is different from |
| \| \| \| \| | the sources not yet decoded by |
| \| \| \| \| | the destination and Â is a |
| \| \| \| \| | decodable set (flag equals 1) |
| \| \| \| \| | then step 17. |
| 17. \| \| \| \| Calculation (Â, flag) = | New determination of Â with an |
| \| \| \| \| Â#2(Tₐᵥ,S̅_{d,t-1}) | up-to-date set S̅_{d,t-1} is needed |
| \| \| \| \| | when Â is a decodable set, |
| \| \| \| \| | according to annex A |
| 18. \| \| \| \| End of if | |
| 19. \| \| End of if | |
| 20. \| \| \| if (i ∉ S_{d,t-1} and flag = 0 and Nᵢ = | While xᵢ exceeds Tₐᵥ, the source |
| \| \| \| Nₘₐₓ) then | i remains incorrectly decoded |
| \| \| \| | even though it has already been |
| \| \| \| | assisted Nₘₐₓ times |
| 21. \| \| \| The nodes send their set of | The destination requires a |
| \| \| \| correctly decoded sources, Sₐ_{_{l−1}} | decode control exchange |
| 22. \| \| \| update of xᵢ | Update xᵢ on the basis of the |
| \| \| \| | equivalent nodes-destination |
| \| \| \| | channel |
| 23. \| \| \| \| if (xᵢ > Tₐᵥ) then | if xᵢ is still greater than the time |
| \| \| \| \| | remaining Tₐᵥ then: |
| 24. \| \| \| \| F ← F∪{i} | add the source i to the list of |
| \| \| \| \| | sources that the destination will |
| \| \| \| \| | no longer assist |
| 25. \| \| \| \| Â ← S̅_{d,t-1} \F | The set of sources to assist Â |
| \| \| \| \| | identified by the flag = 0 as a |
| \| \| \| \| | “non-decodable” set is updated |
| \| \| \| \| | with the sources that have not |
| \| \| \| \| | yet been correctly decoded |
| \| \| \| \| | minus those of F |
| 26. \| \| \| \| exit = 1 | Exit the 2nd “while” loop with |
| \| \| \| \| | this set Â updated |
| 27. \| \| \| \| End of if | |
| 28. \| \| \| End of if | |
| 29. \| \| End of while | |
| 30. \| End of while | |

1. A method for transmitting a frame carrying messages intended for an orthogonal multiple-access multiple-relay channel (OMAMRC) telecommunication system, having N nodes, including M sources sᵢi∈{1, . . . , M} and a destination (d), N≥M≥2, the nodes operating in half-duplex mode, according to an orthogonal multiple-access scheme of the transmission channel between the N nodes with a maximum number of M+Tₘₐₓ time slots per transmitted frame, which are distributed between a first phase and a second phase, 1≤Tₘₐₓ, the message from a source having been coded prior to transmission according to an incremental-redundancy coding that generates multiple redundancies of said message, the first phase comprising M slots respectively allocated to the successive transmissions of the M sources and the second phase comprising at least one retransmission slot for a transmission of nodes that have correctly decoded the same source, which transmission is such that these nodes simultaneously transmit during the same retransmission slot the same redundancy of the message, generated according to the incremental-redundancy coding of the same source not yet correctly decoded by the destination, referred to as the source to assist, the method comprising:
at least one decoding control exchange between the destination and the nodes, the decoding control exchange enabling the destination to determine, for each of the sources, a quality of an equivalent channel that is based on a quality of the channels between the nodes that have correctly decoded a source i and the destination,
an estimation of a number of retransmission slots sufficient for the destination to decode a source (sᵢ) not yet correctly decoded that has been correctly decoded by at least one node based on the quality of an equivalent channel for that source between that at least one node and the destination and a throughput assigned to that source (sᵢ),
a selection by the destination of the sources to assist taking into account the estimated numbers of retransmission slots sufficient for the destination to decode the sources that have not yet been correctly decoded and a sum of throughputs assigned to the sources, and
a number of retransmission slots per source defining an authorized duration to assist a source during this authorized duration limited by a time remaining until Tₘₐₓ even if the estimated number of retransmission slots sufficient for this source is greater than the time remaining.

2. The method of claim 1, further comprising, if the time remaining is not zero, a decoding control exchange between the destination and the nodes so that the destination re-estimates a number of retransmission slots sufficient for the destination to decode a source i, this source having been assisted for the authorized duration but not yet decoded correctly by the destination.

3. The method of claim 2, wherein only the nodes that have correctly decoded the source i transmit a decoding indicator (Info_i) of this source i.

4. The method of claim 2, wherein only the nodes that have correctly decoded the source i transmit their set of correctly decoded sources.

5. The method of claim 2, wherein the nodes transmit at least their set of correctly decoded sources not yet correctly decoded by the destination.

6. The method of claim 1, wherein the at least one decoding control exchange comprises a transmission by the nodes of at least their set of correctly decoded sources not yet correctly decoded by the destination, which is carried out at the beginning of the second phase.

7. The method of claim 1, further comprising a comparison between a sum of estimated numbers of retransmission slots to assist the destination in decoding sources not yet correctly decoded and a number of time slots remaining during the second phase to assist the destination in correctly decoding one or more sources.

8. The method of claim 7, wherein the comparison is updated after the correct decoding of a source by the destination.

9. The method of claim 1, wherein a transmission by the nodes of at least their set of correctly decoded sources not yet correctly decoded by the destination forms part of a control exchange during which the source transmits its set of correctly decoded sources.

10. The method of claim 9, wherein, during the control exchange, a node sends only its set of correctly decoded sources not yet correctly decoded by the destination.

11. The method of claim 9, wherein, during the control exchange, a node sends its set of correctly decoded sources.

12. The method of claim 1, further comprising a comparison between the estimated numbers of retransmission slots sufficient for the selection to take into account a scheduling of these estimated sufficient numbers of retransmission slots.

13. The method of claim 1, further comprising a determination of a set of sources to assist taking into account the estimated sufficient numbers of retransmission slots and a time remaining before the end of the second phase.

14. The method of claim 13, wherein the set of sources to assist contains all the undecoded sources when none of the sufficient numbers of retransmission slots is less than the time remaining.

15. A communication device adapted to implement the method for transmitting a frame carrying messages of claim 1, intended for an orthogonal multiple-access multiple-relay channel, telecommunication (OMAMRC) system having N nodes, including M sources sᵢi∈{1, . . . , M} and a destination, N≥M≥2, said destination being said communication device.

16. A system comprising N nodes, including M sources sᵢi∈{1, . . . , M} and a destination, N≥M≥2, for implementing the method of claim 1.
